(19) United States
(12) Patent Application Publication
(10) Pub. No.: US 2025/0144963 A1
(43) Pub. Date: May 8, 2025

(54) SYSTEM AND METHOD FOR TIRE BALANCING

(71) Applicant: COUNTERACT BALANCING BEADS INC., Guelph (CA)

(72) Inventor: Mishelle LEBLANC, Guelph (CA)

(21) Appl. No.: 18/835,375

(22) PCT Filed: Feb. 8, 2023
(86) PCT No.: PCT/CA2023/050162

§ 371 Date: Aug. 2, 2024

Related U.S. Application Data
(60) Provisional application No. 63/307,717, filed on Feb. 8, 2022.

(51) Int. Cl. B60C 19/00; F16F 15/36

(52) U.S. Cl. CPC B60C 19/003; F16F 15/363

(57) ABSTRACT

A set of tire balancing beads including a set of solid non-absorbent beads; and a set of super moisture absorbent beads.

### CROSS-REFERENCE TO OTHER APPLICATIONS

The current disclosure claims priority from U.S. Provisional Application No. 63/307,717 filed Feb. 8, 2022, which is hereby incorporated by reference.

### FIELD

The disclosure is generally directed at the automotive industry and more specifically at a system and method for tire balancing.

### BACKGROUND

In the automotive industry, there is a need to protect tires from wear and tear in order to prolong the longevity of the tires. There currently exists several solutions that are used inside tires (such as within the tire cavity) to provide both vibration dampening and tire balancing effects. However, each of these products have some disadvantages that are currently not addressed.

When there is moisture build-up or collection in a tire cavity, different problems may arise. Firstly, internal tire moisture has several detrimental effects, including internal rim corrosion. Corroded rims can weaken and fail over time but, initial corrosion can cause bead and valve core leaks. Moisture in the tires also causes greater pressure fluctuations within the tires in response to temperature changes. Along with that, tire belts can rust, especially if there is a puncture, improper repair or any bead damage. Water vapor also absorbs and holds heat which increases as tires are in motion and as temperatures heat up outside. Tires inflated with air tend to run hotter and to fluctuate in pressure, increasing the chances of a blowout and/or an inaccurate reading when checking tire pressure. Also, when moisture changes from liquid to vapor, the moisture (water) expands in volume, decreasing tire handling, tire life, and fuel efficiency.

One disadvantage of current tire balancing solutions that include a free flowing granular or microbead system occurs when moisture becomes present in the tire cavity. Besides the negative effects of water in tires, the excess moisture can cause the free flowing microbeads to clump together. Once the product, or microbeads, have clumped together, the clumped microbeads may clog tire valves or the tires may also require re-balancing.

In some current systems, coating the microbeads in silicon or other hydrophobic treatments helps reduces this effect but in extreme conditions (humidity or cold), this treatment will not always be enough to counter the effects of extreme excess moisture.

Therefore, there is provided a novel system and method for tire balancing.

### SUMMARY

The disclosure is directed at a system and method for tire balancing that includes a mixture of non-absorbent material or beads and moisture absorbing material or beads.

In one aspect of the disclosure, there is provided a set of tire balancing beads including a set of solid non-absorbent beads; and a set of super moisture absorbent beads.

In another aspect, the set of solid non-absorbent beads comprises glass beads, ceramic beads, non-corrosive metal beads or polymer beads. In a further aspect, the set of moisture absorbent beads comprises polyacrylamide beads or sodium polyacrylate beads. In yet another aspect, the set of solid non-absorbent beads are spherical. In yet a further aspect, the set of solid non-absorbent beads are between about 0.5 mm and 4 mm in diameter. In another aspect, the set of super moisture absorbent beads are granular or spherical in shape. In yet a further aspect, a diameter of the super moisture absorbent beads is less than 10 mm.

In another aspect of the disclosure, there is provided method of balancing a tire including generating a set of solid non-absorbent beads; generating a set of super moisture absorbent beads; and combining the set of solid non-absorbent beads and the set of super moisture absorbent beads to produce a set of tire balancing beads.

In another aspect, before combining the set of solid non-absorbent beads and the set of super moisture absorbent beads, determining a final mass of the tire balancing beads based on tire characteristics. In a further aspect, before combining the set of solid non-absorbent beads and the set of super moisture absorbent beads, determining a ratio the set of solid non-absorbent beads and the set of super moisture absorbent beads for use in the set of tire balancing beads.

### DESCRIPTION OF THE DRAWINGS

Embodiments of the present disclosure will now be described, by way of example only, with reference to the attached Figures.

FIG. 1 is a schematic diagram of a set of tire balancing beads;

FIG. 2a is a photograph showing a set of tire balancing beads after exposure to moisture;

FIG. 2b is another photograph showing a set of tire balancing beads after exposure to moisture; and

FIG. 3 is a flowchart showing a method of manufacturing a set of tire balancing beads.

### DETAILED DESCRIPTION OF THE EMBODIMENTS

The disclosure is directed at system and method for tire balancing. In one embodiment, the disclosure is directed at a bead or microbead mixture that includes a set of microbeads that are made of a super absorbent material, or super moisture absorbent material, such as, but not limited to, a super absorbent polymer (SAP). Examples of SAPs include, but are not limited to, cross-linked polyacrylates and polyacrylamides; cellulose- or starch-acrylonitrile graft copolymers; and cross-linked maleic anhydride copolymers. In another embodiment, the super absorbent polymer may be a polyacrylamide such as, but not limited to, sodium polyacrylate and the like.

In some embodiments, these super absorbent beads may be referred to as water beads. In one embodiment, the water beads may be made from a material that may be seen as a super absorbent carrier of water. In other embodiments, the water beads may be made of a material that is able to hold moisture up to 100 times their weight. In a further embodiment, the water beads may be made of a super moisture absorbent material that is non-toxic. In yet another embodiment, when introduced into the tire cavity having current, or other, microbeads, or a solid tire balancing medium, the water beads absorb and store any excess moisture that is present within the tire cavity. In another embodiment, by pulling the moisture out of the tire cavity via the water beads, the other beads within the tire cavity may generate a more effective electrostatic charge.

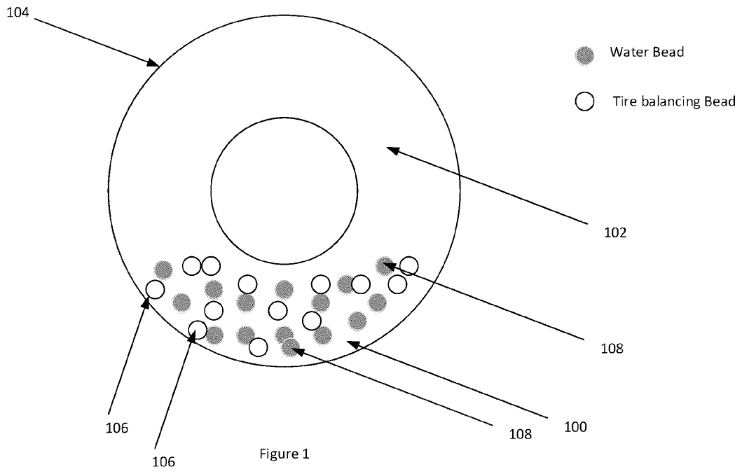

Turning to FIG. 1, a schematic diagram of a set of tire balancing beads in accordance with an embodiment of the disclosure is shown. As shown in FIG. 1, the set of tire balancing beads (or system for tire balancing 100) is located, or placed, within a tire cavity 102 of a tire 104. In the current embodiment, the set of tire balancing beads 100 includes a set of solid non-absorbent shapes or beads 106 and a set of super moisture (water) absorbent shapes or beads 108. In one embodiment, the set of solid non-absorbent beads 106 provide balancing to the tire when the tire is in use while the set of super moisture (water) absorbent beads 108 absorb moisture present within the tire cavity 102. The absorbent beads 108 may also provide balancing to the tire.

In one embodiment, the set of solid non-absorbent beads 106 may be made of a material such as, but not limited to, glass, ceramic, non-corrosive metals, polymers or any other dense material. In another embodiment, the super moisture absorbent beads 108 may be made from a polyacrylamide such as, but not limited to, sodium polyacrylate or similar materials capable of absorbing and retaining water or moisture. In one embodiment, the super absorbent beads 108 may be manufactured from a super absorbent polymer such as a cationic polyacrylamide powder or may be made of acrylic acid, sodium hydroxide and water. Other examples of a super absorbent polymer may include, but are not limited to, a material made from the polymerization of acrylic acid blended with sodium hydroxide in the presence of an initiator to form a poly-acrylic acid sodium salt. In other embodiments, the super absorbent polymer may include a set of polymeric chains that are parallel to each other and regularly linked to each other by cross-linking agents, thus forming a network such that when moisture or water comes into contact with a bead, it is drawn into the molecule by osmosis. The moisture or water then rapidly migrates into the interior of the polymer network where it is stored.

For clarity purposes in FIG. 1, the non-absorbent beads 106 are not filled in while the water beads 108 are filled in. It is understood that in actual embodiments, the non-absorbent beads 106 may be light or dark colored and the water beads 108 may also be light or dark colored. The non-absorbent beads 106 and the water beads 108 may also be the same color. In one embodiment, the set of tire balancing beads 100 weigh a predetermined total combined mass where it may be pre-packaged and then poured or placed inside the tire cavity. In other embodiments, a package of tire balancing beads 100 can be placed inside the tire cavity whereby the packaging can dissolve or disintegrate when the tire starts moving such that the set of balancing beads 100 are released within the tire cavity. In another embodiment, the set of tire balancing beads 100 may only include the set of super moisture (water) absorbent beads 108 which may also provide the dual functionality of absorbing moisture and providing balancing to the tire.

Although shown as being spherical (for instance up to about 10 mm in diameter but preferably up to about 4 mm in diameter) in FIG. 1, the set of solid non-absorbent beads 106 may also be granular or a combination of both spherical and granular shapes. Alternatively, the solid non-absorbent beads 106 may also be in the form of other shapes. For the set of super moisture absorbent beads 108, they may also be spherical in shape (such as being between about 0.5 to about 6 mm in diameter) or may be other shaped. Having beads of spherical shape may reduce the friction between the set of balancing beads and the interior walls of the tire. Larger sizes of beads may be contemplated depending on the type of wheel, or tire, 104 for which the set of balancing beads 100 is being used for.

When placed within a tire cavity 104, the set of solid non-absorbent beads 106 and the set of moisture absorbent beads 108 work together to provide tire balancing and vibration dampening along with the benefit and novel aspects of reducing the amount of moisture within the tire cavity and/or reducing the likelihood, or preventing, the clumping of the solid non-absorbent beads or the clogging of tire valves by the beads 100. The tire balancing aspect or aspects of the solid non-absorbent beads are disclosed, and taught in U.S. Pat. No. 6,128,952 entitled Tire Balancing using Glass Beads to Leblanc which is hereby incorporated by reference.

In one embodiment, any water or moisture (such as but not limited to, any excess, or high level of moisture) in the tire is absorbed by the super moisture absorbent beads 108 (either when the tire is in motion or stationary) allowing the free-flowing material (the solid non-absorbent beads 106) to function as intended inside the tire and to overcome disadvantages of current systems as outlined above. The super absorbent beads 108 may also assist in providing balancing to the tire. If there is lower level of moisture in the tire cavity, the water beads 108 may perform the same function as the set of non-absorbent beads 106 in contributing the required mass to balance the tire and dampen vibrations and may not absorb as much moisture. The addition of water beads to a set of tire balancing beads will also help reduce other detrimental effects of excess moisture in the tire, or tire cavity.

For example, the absorption of moisture may reduce permeation which may be seen as a process by which air in a tire bleeds through the tire's body or carcass. Permeation is typically affected by the relative humidity in the tire. An air-filled tire typically loses one to two pounds per square inch of pressure every month through normal permeation. The presence of the super absorbent beads may decrease the permeability of the tire by reducing the relative humidity of the air in the tire cavity by absorbing the moisture.

In another embodiment, the ratio of solid non-absorbent beads 106 to super moisture absorbent beads 108 may be based on a mass of the combined components (or set of tire balancing beads 100) in the tire or tire cavity. In one embodiment, calculation of the weight or mass of the set of tire balancing beads 100 may be based on a ratio of 1 ounce of balancing material or tire balancing beads 100 per 13 lbs of a tire. In this embodiment, a ratio between the solid non-absorbent beads 106 and super moisture absorbent beads 108 may range from 99:1 to 50:50. In another embodiment, the composition of the set of tire balancing beads may be based on the characteristics of the tire or the environment in which the tire is being used.

In a further embodiment, the set of tire balancing beads 100 may be installed or placed within the tire either through the valve stem or a throw-in bag where the bag breaks down when the wheel starts moving and the set of tire balancing beads are dispersed.

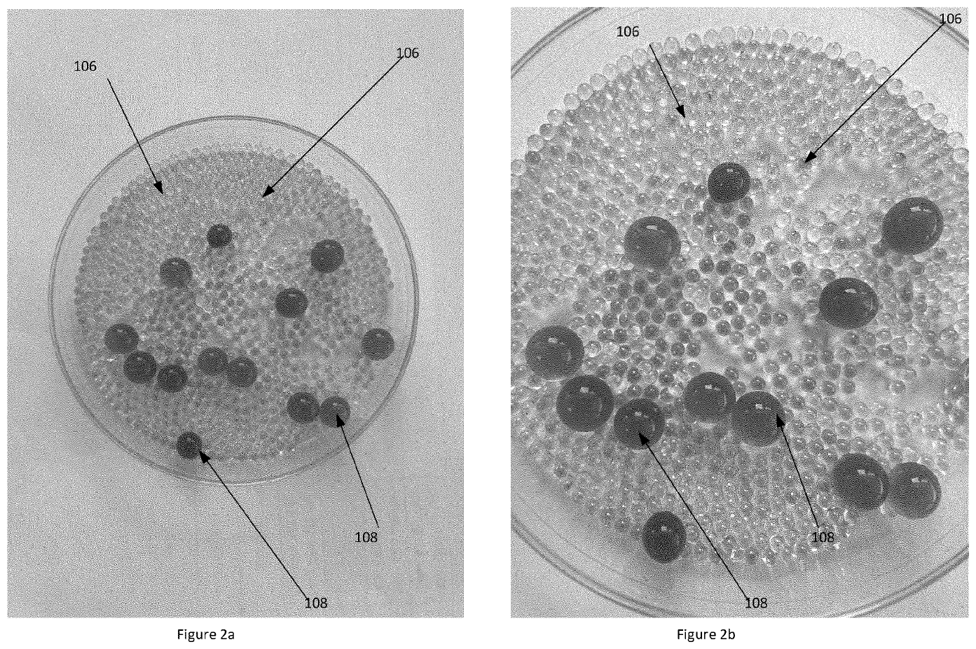

As schematically shown in FIGS. 2a and 2b, which are photographs showing a set of tire balancing beads that have been exposed to water/moisture, the super moisture absorbent beads 108 are larger in size than the solid non-absorbent beads 106 due to the absorption of moisture.

By including the super moisture absorbent beads 108 that are able to absorb moisture, detrimental effects of moisture on a tire or a tire cavity can be reduced or eliminated. As discussed above, some detrimental effects may include internal rim corrosion, valve core leaks and/or tire pressure fluctuations.

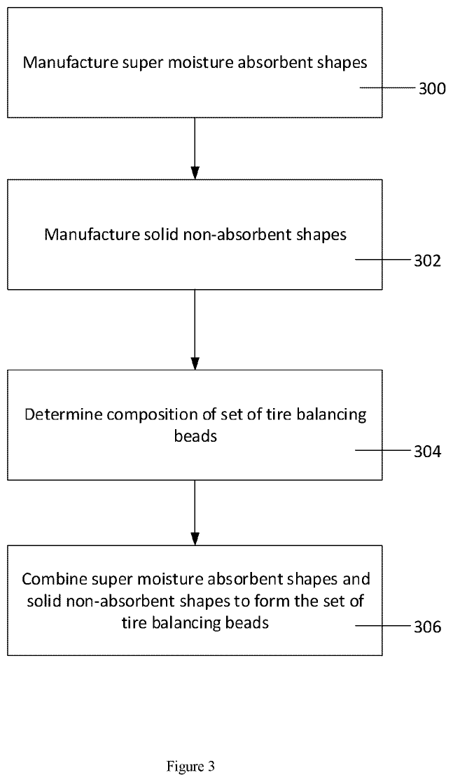

Turning to FIG. 3, a method of making a set of tire balancing beads is shown. Initially, a set of super moisture absorbent shapes are manufactured (300). In one embodiment, the super moisture absorbent shapes are spherical or bead-like in shape. A set of solid non-absorbent shapes, such as beads, are then manufactured (302). It is understood that there is no chronological order to the manufacture of the set of super moisture absorbent shapes and the set of solid non-absorbent shapes and that the solid non-absorbent shapes may also be manufactured before or concurrent with the manufacture of the super moisture absorbent shapes.

The composition of the system for tire balancing or the set of tire balancing beads is then determined or calculated (304). In one embodiment, a final mass of the tire balancing beads and/or a ratio of solid non-absorbent shapes and the super moisture absorbent shapes may be calculated based on the characteristics of a tire for which the set of balancing beads is being used. In other embodiments, the determination may be based on conditions or the environment (such as, but not limited to, weather conditions) within which the tire is being used.

The solid non-absorbent shapes and the super moisture absorbent shapes are then combined to form the system for tire balancing or a set of tire balancing beads (306) based on the determination from (304). The set of tire balancing beads can then be placed or inserted into a tire cavity. As discussed above, the set of tire balancing beads may be introduced into the tire cavity via the valve or may be packaged in a bag and the bag then placed in the tire cavity whereby the bag dissolves when inside of the tire cavity thereby releasing the contents of the bag into the tire cavity.

While various embodiments have been described above, it should be understood that they have been presented only as illustrations and examples of the present disclosure, and not by way of limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment.

What is claimed is:

1. A set of tire balancing beads comprising:
a set of solid non-absorbent beads; and
a set of super moisture absorbent beads.

2. The set of tire balancing beads of claim 1 wherein the set of solid non-absorbent beads comprises glass beads, ceramic beads, non-corrosive metal beads or polymer beads.

3. The set of balancing beads of claim 1 wherein the set of moisture absorbent beads comprises polyacrylamide beads or sodium polyacrylate beads.

4. The set of balancing beads of claim 1 wherein the set of solid non-absorbent beads are spherical.

5. The set of balancing beads of claim 1 wherein the set of solid non-absorbent beads are between about 0.5 mm and 4 mm in diameter.

6. The set of balancing beads of claim 1 wherein the set of super moisture absorbent beads are granular or spherical in shape.

7. The set of balancing beads of claim 6 wherein a diameter of the super moisture absorbent beads is less than 10 mm.

8. A method of balancing a tire comprising:
generating a set of solid non-absorbent beads;
generating a set of super moisture absorbent beads;
combining the set of solid non-absorbent beads and the set of super moisture absorbent beads to produce a set of tire balancing beads.

9. The method of claim 8 further comprising, before combining the set of solid non-absorbent beads and the set of super moisture absorbent beads:
determining a final mass of the tire balancing beads based on tire characteristics.

10. The method of claim 8 further comprising, before combining the set of solid non-absorbent beads and the set of super moisture absorbent beads:
determining a ratio the set of solid non-absorbent beads and the set of super moisture absorbent beads for use in the set of tire balancing beads.
